(19) United States
(12) Patent Application Publication
(10) Pub. No.: US 2011/0164342 A1
(43) Pub. Date: Jul. 7, 2011

(54) ELECTRICALLY CONDUCTIVE BAND

(76) Inventors: Roland Hee, Penang (MY); Julienne Marie Hee, Penang (MY)

(21) Appl. No.: 13/051,230

(22) Filed: Mar. 18, 2011

Related U.S. Application Data
(63) Continuation of application No. 12/793,880, filed on Jun. 4, 2010.
Application No. 12/793,880 is a continuation of application No. 11/901,756, filed on Sep. 19, 2007, now abandoned.

(51) Int. Cl. H05F 3/02

(52) U.S. Cl. 361/220

(57) ABSTRACT

There is provided an electrically conductive band wearable on a user. The band includes an extendable strap having first and second end portions and a contact surface. The strap is formed of electrically conductive threads distributed along the contact surface. The band further includes a buckle including a recessed notch having a conduction member disposed therein. The conduction member is electrically connected to the conductive threads when the conductive threads are in contact with the conduction member. The buckle also includes a fastening element that is in electrical communication with the conduction member and is electrically connectable to a grounding wire. The buckle further includes a locking member being pivotable to secure the conductive threads adjacent the conduction member. A primary connector is coupled to the second end portion of the strap and includes a primary attaching portion that is attachable to a buckle attaching element.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

1. Field of the Invention

The present invention relates generally to electrically conductive bands, and more particularly to electrically conductive bands that are wearable on a user and connectable to a grounding wire.

2. Description of the Related Art

The routine handling of static-sensitive electronic components is plagued by problems related to static electricity. Static electricity may damage electronics, particularly integrated circuits and other microelectronic components. The static electricity may disable or destroy such electrical components by over-voltage or power density. Certain junctions within the components may be destroyed by as little as a 50-volt potential. However, when a person performs simple day-to-day activities, he may generate large amounts of static electricity. For instance, a person walking on a carpet on a dry day may accumulate as much as 30,000 volts of potential. A person may also generate thousands of volts by simply changing his position in his chair or handling a Styrofoam cup.

A person who has generated static electricity may inadvertently discharge the static electricity into an electrical component by touching it. Accordingly, it is common practice for personnel in industries in which electrical components are frequently handled or assembled to take measures to limit the discharge of static electricity into the components. Such a discharge may be prevented by keeping the worker at a zero electrical potential.

A grounding band is a tool that is commonly used to mitigate the electrical charge of a worker. If used properly, the grounding band may be a helpful tool in keeping the worker at or near a zero electrical potential. However, improper usage of the grounding band is likely to reduce the effectiveness thereof. A typical grounding band includes a conductive surface that is electrically connectable to the user. Many grounding bands achieve such an electrical connection by placing the conductive surface in contact with the user's skin. The conductive surface is generally electrically connected to a grounding cord which leads from the band to a grounded electrical connection. Therefore, the electric charge is dissipated from the user to ground.

Although the grounding band is an effective tool for mitigating the amount of static electricity buildup on the user, repeated use of the band may result in deterioration of the band. The conductive surface may become dirty or fouled by oil, perspiration or hair, which mitigates the band's effectiveness. Most grounding bands must be completely replaced when the conductive surface loses its effectiveness.

Furthermore, the conductive surface may lose its electrical connection with the wearer's skin if the strap is or becomes too loose. In some cases, the grounding strap includes an elastic band which enables the strap to fit snugly on the wearer. After frequent and repeated use, the elasticity of the band may deteriorate. If the elasticity deteriorates to the point where the electrical connection between the wearer and the conductive surface is lost, the grounding strap may need to be replaced.

As is apparent from the foregoing, there exists a need in the art for an improved electrically conductive band that includes a conductive surface which may easily be replaced after long and repeated use. Furthermore, there is also a need in the art for an electrically conductive band that is adjustable to enable a proper fit on a wearer to maximize the effectiveness of the band.

### BRIEF SUMMARY OF THE INVENTION

According to an aspect of the present invention, there is provided an electrically conductive band wearable on a user. The electrically conductive band is configured to transfer electrical charge from a user to ground. The electrically conductive band includes a strap having first and second end portions and a contact surface. The strap is extendable along a longitudinal axis. The strap is formed of electrically conductive threads distributed along the contact surface. The contact surface is positionable on the user to electrically connect the conductive threads to the user.

The electrically conductive band further includes a buckle having a buckle body. The buckle body includes a body top surface and a body bottom surface. The body top surface includes a recessed notch extending toward the body bottom surface. A conduction member is disposed within the recessed notch. The conduction member is formed of electrically conductive material and is electrically connected to the conductive threads when the conductive threads are in contact with the conduction member. The buckle also includes a fastening element disposed at the body top surface. The fastening element is electrically conductive and is in electrical communication with the conduction member. The fastening element is additionally electrically connectable to a grounding wire. The grounding wire communicates electrical charge from the electrically conductive band to ground. The buckle also includes a locking member that is pivotally connected to the buckle body. The locking member is pivotable to secure the conductive threads adjacent the conduction member. The buckle further includes a buckle attaching element connected to the buckle body.

The electrically conductive band additionally includes a primary connector coupled to the second end portion of the strap. The primary connector includes a primary attaching portion that is attachable to the buckle attaching element.

An aspect of the present invention allows quick and easy replacement of the strap and primary connector when the strap becomes ineffective or dirty. In other words, the buckle does not have to be replaced when the strap is replaced. The strap is detachably connected to the buckle via the primary connector on one end, and the locking member on the other end. Therefore, if the strap becomes dirty or otherwise becomes ineffective after long and continuous use, the buckle may be reused with a new strap and primary connector. Consequently, the cost of replacing an ineffective strap is reduced. Furthermore, if the buckle becomes damaged for any reason, a new buckle may be used on an exiting strap.

The electrically conductive band may further include a secondary connector having a secondary attaching portion and a secondary attaching element. The secondary attaching portion is attachable to the buckle attaching element, and the secondary attaching element is attachable to the primary attaching portion. The secondary connector may be connected to the primary connector and the buckle attaching element to increase the size of the electrically conductive band.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings in which like numbers refer to like parts throughout and in which:

FIG. 1 is a top perspective view of an embodiment of an electrically conductive band constructed in accordance with the present invention, the electrically conductive band being positioned on a wrist of a user shown in phantom;

FIG. 2 is an enlarged top perspective view of the electrically conductive band illustrated in FIG. 1;

FIG. 3 is a top perspective view of the electrically conductive band as illustrated in FIG. 2, the electrically conductive band including a buckle and a secondary connector, the buckle being detached from a strap and the secondary connector;

FIG. 4 is a side sectional view of the electrically conductive band illustrated in FIG. 2; and

FIG. 5 is a side view of the electrically conductive band, the electrically conductive band being extendable along a longitudinal axis.

### DETAILED DESCRIPTION OF THE INVENTION

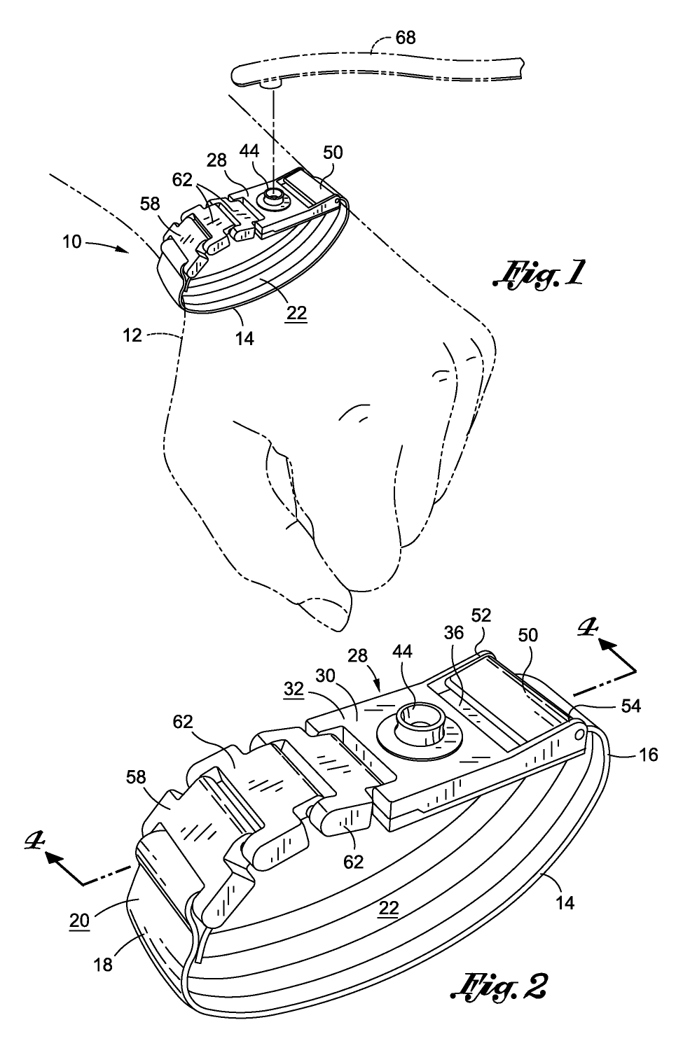

Referring now to the drawings wherein the showings are for purposes of illustrating a preferred embodiment of the present invention only, and not for purposes of limiting the same, FIGS. 1-5 illustrate an electrically conductive band 10 constructed in accordance with the present invention. It is contemplated that the electrically conductive band 10 is configured to mitigate an inadvertent discharge of electrical current from a user 12 to an electrical component. The electrically conductive band 10 is positionable on a user 12 to enable the transfer of electric current from the user 12 to ground. In this regard, the electrically conductive band 10 is in electrical communication with the user 12 upon proper placement of the band 10 upon the user 12. The band 10 may be positioned at a comfortable and convenient location on the user 12, such as a limb (e.g., leg or arm). As shown in FIG. 1, the band 10 is positioned on the user's wrist.

According to an aspect of the present invention, the electrically conductive band 10 includes a buckle 28 which may be detached from a strap 14 on one end, and a primary or secondary connector 58, 62 on the other end. In this regard, if the strap 14 becomes dirty or soiled, or otherwise becomes ineffective, a new strap 14 may be used with an existing buckle 28. Furthermore, as will be described in more detail below, one or more secondary connectors 62 may be added/removed from the electrically conductive band 10 to increase/decrease the size thereof.

According to various embodiments of the present invention, and as indicated above, the electrically conductive band 10 includes a strap 14. It is contemplated that the strap 14 is comprised of an elastic material to enable extension of the strap 14 along a longitudinal axis 24. The strap 14 includes opposing exterior and contact surfaces 20, 22, and first and second end portions 16, 18. At least one electrically conductive thread 26 is distributed along the contact surface 22 of the strap 14. The electrically conductive thread 26 is configured to communicate electric current along its length. The embodiment illustrated in FIGS. 1-3 includes a plurality of electrically conductive threads 26. The contact surface 22 of the strap 14 is positionable adjacent the user's skin to electrically connect the conductive threads 26 to the user 12. The conductive threads 26 may be exposed on the contact surface 22 to enable direct contact with the user 12 when the contact surface 22 is positioned on the user 12. However, it is understood that certain embodiments of the electrically conductive band 10 include conductive threads 26 which may not be exposed. Rather, the strap 14 may include an intermediate coating or layer disposed between the conductive threads 26 and the user 12. Such an intermediate coating or layer does not interfere with the electrical connection between the conductive threads 26 and the user 12.

In one embodiment, the electrically conductive threads 26 extend along the contact surface 22 in a generally linear manner substantially parallel to the longitudinal axis 24. In another embodiment, the threads 26 may be disposed along the contact surface 22 in a serpentine path. The serpentine path allows the threads 22 to readily expand and contract along the longitudinal axis 24 of the strap 14. Furthermore, the conductive threads 26 may be visually pronounced to facilitate visual inspection thereof for continuity which indicates the operativeness of their electrically conductive function. According to a particular implementation, the electrically conductive threads 26 are electrically insulated from the exterior surface 20. In this regard, electric charge from the electrically conductive threads 26 is not transferred to the exterior surface 20.

The electrically conductive band 10 further includes a buckle 28 having a buckle body 30. The buckle body 30 includes a body top surface 32 and a body bottom surface 34. The body top surface 32 includes a recessed notch 36 extending downwardly toward the body bottom surface 34. A conduction member 38 formed of electrically conductive material is coupled to the buckle body 30. The conduction member 38 is electrically connectable to the conductive threads 26. An electrical connection is established between the conductive threads 26 and the conduction member 38 when the conductive threads 26 are in contact with the conduction member 38. In the embodiment depicted in FIG. 4, the conduction member 38 includes a bottom portion 42 that extends along the body bottom surface 34, and a notch portion 40 disposed within the recessed notch 36. According to the embodiment illustrated in FIG. 4, the electrically conductive threads 26 are in contact with the notch portion 40 of the conduction member 38.

The buckle 28 further includes a fastening element 44 disposed at the body top surface 32. The fastening element 44 is electrically conductive and is in electrical communication with the conduction member 38. According to one embodiment of the present invention, such electrical communication may be achieved via direct contact. In another embodiment, the electrical communication may be achieved via an intermediate conducting element connected to the conduction member 38 and the fastening element 44. As best shown in FIG. 4, the fastening element 44 is in electrical communication with the conduction member 38 via a rivet 46. In this manner, electrical current is transferred from the conduction member 38 to the fastening element 44 along the rivet 46. The rivet 46 is attached to the bottom portion 42 of the conduction member 38 and extends to the fastening element 44. One particular implementation of the invention includes a conduction member 38 having an indentation along the bottom portion 42. The rivet 46 sits within the indentation 48 and does not protrude beyond the plane of the bottom portion 42 of the conduction member 38. In this respect, the rivet 46 is confined within the indentation 48 and does not rub against the user 12. Although the foregoing discusses the use of a rivet 46 as an intermediate conduction member, it is important to note that the intermediate conduction member is not limited thereto.

The fastening element 44 is electrically connectable to a grounding wire 68 or other grounding elements. To this end, the grounding wire 68 is a conduit which enables the transfer of electrical charge from the electrically conductive band 10 to ground. When the fastening element 44 is attached to the grounding wire 68, the movement of the user 12 may be restricted by the length of the grounding wire 68. Therefore, the fastening element 44 may be configured to allow quick and easy detachment of the fastening element 44 from the grounding wire 68 to enable the user 12 to move beyond the limited distance allowed by the grounding wire 68. According to one embodiment, the fastening element 44 may be a snap fastener, as shown in FIG. 1, which snaps onto the grounding wire 68. In this regard, the grounding wire 68 may include a corresponding grounding fastener that is electrically connectable to the fastening element 44 located on the buckle 28. For instance, the fastening element 44 and grounding fastener may include complimentary male and female connectors. In another embodiment, the fastening element 44 may connect to the grounding wire 68 via magnetic attraction.

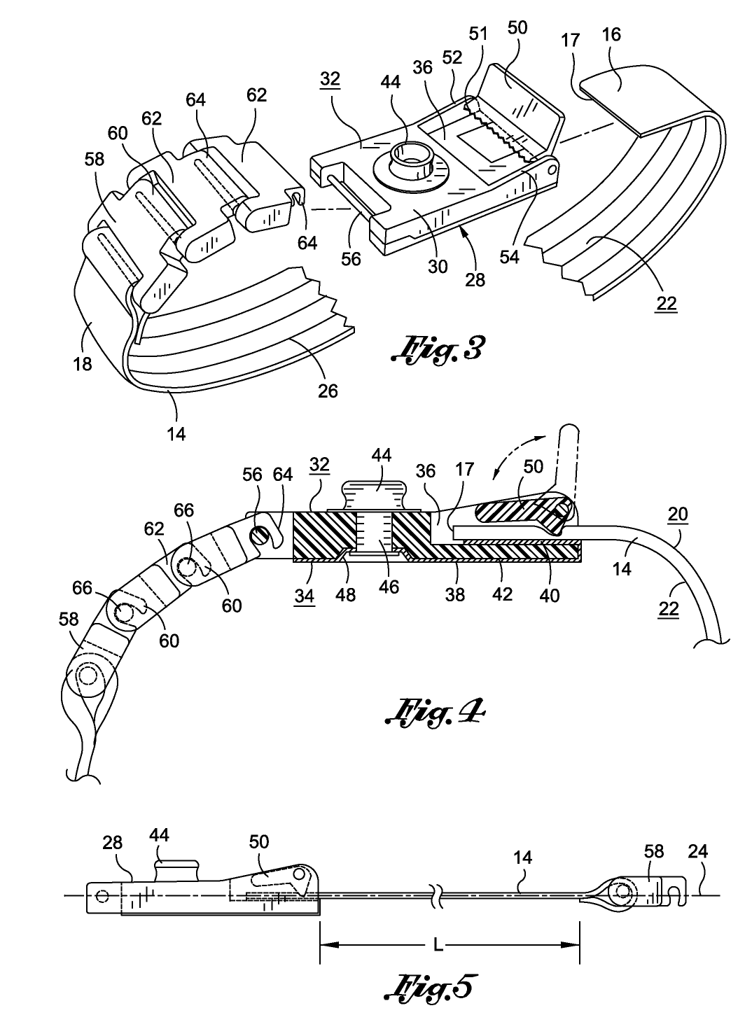

The buckle 28 also includes a locking member 50 that is pivotally connected to the buckle body 30. The locking member 50 is pivotable to secure the conductive threads 26 adjacent the conduction member 38 to facilitate electrical communication between the conductive threads 26 and the conduction member 38. In the embodiment shown in FIGS. 1-5, the locking member 50 is pivotally connected to first and second body walls 52, 54 formed by the recessed notch 36. However, it is understood that the locking member 50 may be pivotally connected to any portion of the buckle body 30 without departing from the spirit and scope of the present invention. It is contemplated that a particular embodiment of the present invention includes a locking member 50 having a serrated edge 51, as best shown in FIG. 3. The serrated edge 51 is configured to enhance the gripping of the strap 14.

The buckle 28 further includes a buckle attaching element 56 connected to the buckle body 30. In one embodiment, the buckle attaching element 56 is integrally connected to the buckle body 30. However, in other embodiments, the buckle attaching element 56 may be detachably connected to the buckle body 30.

The electrically conductive band 10 additionally includes a primary connector 58 coupled to the second end portion 18 of the strap 14. According to various embodiments, the primary connector 58 may be permanently connected to the strap 14 or the primary connector 58 may be slidably connected to the strap 14. The primary connector 58 includes a primary attaching portion 60 that is attachable to the buckle attaching element 56. According to an aspect of the present invention, the primary attaching portion 60 is pivotally attachable to the buckle attaching element 56. In this regard, the primary connector 58 is able to pivot relative to the buckle 28 when the primary connector 58 is attached to the buckle 28. This allows the band 10 to conform to the user 12 to create a secure and comfortable fit. It is contemplated that the primary attaching portion 60 may be attached to the buckle attaching element 56 to dispose the electrically conductive band 10 in a wearable configuration. When the electrically conductive band 10 is in the wearable configuration, it may be arranged circumferentially about a limb of the user 12. The elasticity of the strap 14 allows the user 12 to fit the band 10 about the user's limb. With the electrically conductive band 10 correctly positioned on the user 12 and connected to the grounding wire 68, the user 12 is effectively grounded to zero electrical potential. Thus, there is no unintentional static discharge to the electrical components which could potentially cause damage.

As noted above, the buckle 28 is connectable to the primary connector 58 via the buckle attaching element 56, and is also connectable to the strap 14 via the locking member 50. In this regard, the buckle 28 may be connected to or detached from the strap/connector assembly. Therefore, the buckle 28 may be reused with various strap/connector assemblies. Alternatively, various buckles 28 may be used with a single strap/connector assembly. It is contemplated that the strap 14 may need to be replaced after long and repeated use. For instance after the strap 14 is stretched several times, the strap 14 tends to assume the stretched length. Furthermore, such use of the strap 14 may result in dirt and sweat accumulating thereon. Such dirt and sweat may deteriorate the aesthetic and utilitarian qualities of the strap 14. When the strap 14 becomes dirty or otherwise ineffective, a new strap 14 may be used with an exiting buckle 28. In this regard, the user 12 does not need a whole new band 10. Rather, all that is needed is a new strap 14. If the primary connector 58 is permanently attached to the strap 14, then a new primary connector 58 would also be needed. However, if the primary connector 58 is detachably connected to the strap 14, a new primary connector 58 may not be needed.

The length “L” of the strap 14 may be adjusted in order to accommodate the size of a particular user 12. The length L of the strap 14 is defined as the distance along the strap 14 between the buckle 28 and the primary connector 58 when the strap 14 is connected to the buckle 28. The length L of the strap 14 is adjusted by varying the distance between the primary connector 58 and the buckle 28. In this regard, the buckle 28 may slide toward the primary connector 58 to shorten the length L of the strap 14. The length L of the strap 14 may be increased by sliding the buckle 28 away from the primary connector 58. In embodiments where the primary connector 58 is slidably attached to the strap 14, the primary connector 58 may slide toward/away from the buckle 28 to decrease/increase the length L of the strap 14, respectively.

As best shown in FIG. 4, the first edge 17 of the first end portion 16 is disposed within the recessed notch 36. Disposing the first edge 17 of the strap 14 within the recessed notch 36 increases the operational safety of the electrically conductive band 10. In this manner, the first edge 17 of the strap 14 is advantageously confined within the recessed notch 36 to prevent the strap 14 from snagging on nearby equipment, which may cause the strap 14 to rip or tear. As such, it may be desirable to confine the first edge 17 within the recessed notch 36. It is understood that the first edge 17 may become exposed after adjusting the length L of the strap 14 to fit a particular user 12. Therefore, subsequent to adjusting the length L of the strap 14, the exposed portion of the strap 14 may be trimmed such that the first edge 17 is confined within the recessed notch 36 when the electrically conductive band 10 is worn by a user 12. Although it may be desirable to disposed the first edge 17 within the recessed notch 36, it is not required.

As indicated above, the size of the electrically conductive band 10 may be adjusted by varying the length L of the strap 14. However, the size may also be varied by inserting a secondary connector 62 into the electrically conductive band 10. Therefore, one embodiment of the invention includes a secondary connector 62 having a secondary attaching portion 64 and a secondary attaching element 66. The secondary attaching portion 64 is attachable to the buckle attaching element 56, and the secondary attaching element 66 is attachable to the primary attaching portion 60. Therefore, if a particular electrically conductive band 10 is worn by different users, one or more secondary connectors 62 may be added or removed to adjust the size of the band 10 to accommodate each user 12.

According to one embodiment, the secondary attaching portion 64 is pivotally attachable to the buckle attaching element 56. Furthermore, the secondary attaching element 66 is pivotally attachable to the primary attaching portion 60. In this regard, the secondary connector 62 may pivot relative to the buckle 28 and the primary connector 58 to enable the band 10 to conform to the user 12.

When multiple secondary connectors 62 are used, the secondary attaching element 66 of one secondary connector 62 attaches to the primary attaching portion 60 of the primary connector 58. The secondary attaching portion 64 of the secondary connector 62 attaches to the secondary attaching element 66 of another secondary connector 62. Additional secondary connectors 62 may be attached together to increase the size of the band 10. The secondary attaching portion 64 of one of the secondary connectors 62 attaches to the buckle attaching element 56.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1. An electrically conductive band wearable on a user, the electrically conductive band comprising:
a strap having a first end portion, a second end portion, and a contact surface, the strap being connected to itself adjacent the second end portion to define a loop, the strap being extendable along a longitudinal axis, the strap being formed of electrically conductive threads distributed along the contact surface, the contact surface being positionable on the user to electrically connect the conductive threads to the user;
a buckle having:
a buckle body, the buckle body having a body top surface and a body bottom surface, the body top surface having a recessed notch extending toward the body bottom surface;
a conduction member disposed within the recessed notch, the conduction member being formed of electrically conductive material, the conduction member being electrically connected to the conductive threads when the conductive threads are in contact with the conduction member;
a fastening element disposed at the body top surface, the fastening element being electrically conductive, the fastening element being in electrical communication with the conduction member, the fastening element being electrically connectable to a grounding wire;
a locking member being pivotally connected to the buckle body, the locking member being pivotable to secure the conductive threads adjacent the conduction member; and
a buckle attaching element connected to the buckle body; and
a primary connector coupled to the loop, the primary connector having a primary attaching portion being attachable to the buckle attaching element.

2. The electrically conductive band as recited in claim 1 further comprising a secondary connector having a secondary attaching portion and a secondary attaching element, the secondary attaching portion being attachable to the buckle attaching element, and the secondary attaching element being attachable to the primary attaching portion.

3. The electrically conductive band as recited in claim 1, wherein the first end portion includes a first edge, the locking member being pivotable to secure the first edge within the recessed notch.

4. The electrically conductive band as recited in claim 1 wherein the fastening element is integrally connected to the buckle body.

5. The electrically conductive band as recited in claim 1 wherein the fastening element is a snap fastener.

6. The electrically conductive band as recited in claim 1 wherein the recessed notch defines a first body wall and a second body wall.

7. The electrically conductive band as recited in claim 1 wherein the locking member is pivotally connected to the first and second body walls.

8. The electrically conductive band as recited in claim 1 wherein the primary attaching portion is pivotally attachable to the buckle attaching element.

9. The electrically conductive band as recited in claim 2 wherein the secondary attaching portion is pivotally attachable to the buckle attaching element.

10. The electrically conductive band as recited in claim 2 wherein the secondary attaching element is pivotally attachable to the primary attaching portion.

11. An electrically conductive band wearable on a user, the electrically conductive band comprising:
a strap having a first end portion, a second end portion, and a contact surface, the strap being connected to itself adjacent the second end portion to define a loop, the strap being extendable along a longitudinal axis, the strap being formed of electrically conductive threads distributed along the contact surface, the contact surface being positionable on the user to electrically connect the conductive threads to the user;
a buckle having:
a buckle body, the buckle body having a body top surface and a body bottom surface, the body top surface having a recessed notch extending toward the body bottom surface;
a conduction member disposed within the recessed notch, the conduction member being formed of electrically conductive material, the conduction member being electrically connected to the conductive threads when the conductive threads are in contact with the conduction member;
a fastening element disposed at the body top surface, the fastening element being electrically conductive, the fastening element being in electrical communication with the conduction member, the fastening element being electrically connectable to a grounding wire;
a locking member being pivotally connected to the buckle body, the locking member being pivotable to secure the conductive threads adjacent the conduction member;
and
a buckle attaching element connected to the buckle body;
a primary connector coupled to the loop, the primary connector having a primary attaching portion; and
a secondary connector having a secondary attaching portion and a secondary attaching element, the secondary attaching portion being attachable to the buckle attaching element, and the secondary attaching element being attachable to the primary attaching portion.

12. The electrically conductive band as recited in claim 11, wherein the first end portion includes a first edge, the locking member being pivotable to secure the first edge within the recessed notch.

13. The electrically conductive band as recited in claim 11 wherein the fastening element is integrally connected to the buckle body.

14. The electrically conductive band as recited in claim 11 wherein the fastening element is a snap fastener.

15. The electrically conductive band as recited in claim 11 wherein the recessed notch defines a first body wall and a second body wall, the locking member being pivotally connected to the first and second body walls.

16. (canceled)

17. (canceled)

18. The electrically conductive band as recited in claim 11 wherein the secondary attaching portion is pivotally attachable to the primary attaching portion.

19. (canceled)

20. An electrically conductive band wearable on a user, the electrically conductive band comprising:
a strap having a first end portion, a second end portion, and a contact surface, the strap being connected to itself adjacent the second end portion to define a loop, the strap being formed of electrically conductive threads distributed along the contact surface, the contact surface being positionable on the user to electrically connect the conductive threads to the user;
a buckle having:
a buckle body, the buckle body having a body top surface and a body bottom surface, the body top surface having a recessed notch extending toward the body bottom surface;
a conduction member connected to the buckle body, the conduction member being formed of electrically conductive material, the conduction member being electrically connected to the conductive threads when the conductive threads are in contact with the conduction member;
a fastening element disposed at the body top surface, the fastening element being electrically conductive, the fastening element being in electrical communication with the conduction member, the fastening element being electrically connectable to a grounding wire; and
a buckle attaching element connected to the buckle body; and
a primary connector coupled to the loop, the primary connector having a primary attaching portion being attachable to the buckle attaching element.

21. The electrically conductive band as recited in claim 1, wherein the strap is secured to itself to define a permanent loop.

22. The electrically conductive band as recited in claim 1, wherein the loop and the primary connector are configured to allow the primary connector to pivot more than 180° relative to the strap.

23. The electrically conductive band as recited in claim 22, wherein the loop and the primary connector are configured to allow the primary connector to pivot approximately 360° relative to the strap.
